(19) United States
(12) Patent Application Publication
(10) Pub. No.: US 2016/0353496 A1
(43) Pub. Date: Dec. 1, 2016

(54) COMMUNICATION METHOD AND APPARATUS

(71) Applicant: Andrew Egendorf, Lincoln, MA (US)

(72) Inventor: Andrew Egendorf, Lincoln, MA (US)

(21) Appl. No.: 14/724,552

(22) Filed: May 28, 2015

(51) Int. Cl. H04W 76/02; H04W 8/18; H04L 29/08

(52) U.S. Cl. CPC H04W 76/023; H04L 67/306; H04W 8/18

(57) ABSTRACT

A communication method and apparatus wherein there is wireless communication with at least two mobile communication devices each having a network address and wherein location-related data is received for the at least two mobile communication devices. A database of profiles of users is maintained including social media information and/or advertising information identifying at least one second user and the second user's network address with whom a first user desires to communicate when the first and second users are at a common location. A contact with the first user, or with the second user, or with both, is initiated automatically by a third party when the location-related data indicates that the first and second users are sufficiently close, the purpose of the contact or contacts being to effect a direct communication between the network address of the first user and the network address of the second user.

### BACKGROUND OF THE INVENTION

The present invention relates to a communication method and an apparatus for implementing the communication method.

The popularity of smartphones has made them almost a necessity for the mobile services that are fast becoming available around the world. These smartphones are mobile handheld computers that have wireless communication capabilities that are just beginning to be exploited.

Many people rely on their smartphones for entertainment, news, shopping, and socializing through the use of voice and text communication, web sites, social media, and social networks. There is therefore a great need for providing services to the users of smartphones, tablets, personal digital assistants, and other mobile communication devices.

The prior art U.S. Pat. No. 6,618,593 to Drutman et al., and the prior art U.S. Pat. No. 7,194,076 to Kotik et al., provide location based services to the users of mobile telephones, but do not provide for the use of social media information, or for one user to call, email, or otherwise directly communicate with the other user, in providing their services. The disclosures of U.S. Pat. Nos. 6,618,593 and 7,194,076 are hereby incorporated by reference herein.

### SUMMARY OF THE INVENTION

The object of the present invention is to improve upon the known communication methods and apparatuses. In one aspect of the present invention, the improvement is achieved by maintaining a database of profiles of users including social media information and/or advertising-related information identifying at least one second user and the second user's network address with whom a first user desires to communicate when the first and second users are at a common location, and automatically initiating a contact with at least one of the first and second users when the location-related data indicates that the first and second users are sufficiently close, the purpose of the contact being to effect a direct communication by the first user to the second user's network address. Contact can be initiated with the first user, the second user, or both users, the purpose of the contacts being to effect a direct communication by the first user to the second user's network address and/or a direct communication by the second user to the first user's network address. It should be understood that the use of the terms “first user” and “second user” do not connote any order, priority, or preference and that these terms are only meant to differently label two users. While the invention has been described as utilizing social media information and/or advertising-related information for identifying users, it is understood that each user can compile a list of identified users without regard to social media and/or advertising, and such lists can contain any combination of persons, businesses, organizations, groups, etc.

In addition, a user can have any number of profiles, each with its own set of parameters, such as its list of identified users, so that each profile can be used for a different purpose, for example, one for personal use, one for business use, one for family use, one for use with friends, etc. For example, a user can set-up two profiles, one with a list of members of a national organization with whom the user desires to socialize, and another with the names of co-workers with whom the user desires to socialize. Because it will be far more unlikely for the user and someone from the first list to be in a common location, than it will be for the user and someone from the second list to be in a common location, the user can set his or her distance parameter for the first profile to a large distance, say 60 miles, and set the distance parameter for the second profile at 1 mile.

Additionally, the third party can offer users the ability to include in their profiles entries based upon one or more characteristics of the user, in lieu of, or in addition to, the user's name. For example, the third party can offer an entry such as “driving on the Massachusetts Turnpike”. Mobile phones with GPS capability can determine the speed at which they are moving by tracking the changes in their GPS location over time. The third party, or another remote source, also can determine the speed of the phone from GPS location data sent to it by the phone. Thus, a user can specify that he or she desires to be contacted by the third party when another driver on the Massachusetts Turnpike within, say, 10 miles, was traveling at a speed between, say, 10 and 30 miles per hour, which will indicate traffic problems. Upon being contacted by the third party, the first user can directly communicate with the second user to find out the actual situation. The contact to the first user can include a map of the location of the second user, thereby helping the first user to avoid the traffic problem.

In accordance with the present invention, this and other objects of the present invention are achieved by a method for communicating wherein a third party, which can be a carrier, an ISP, or an operator of a server on the Internet, wirelessly communicates with at least two mobile communication devices each having a network address, receives location-related data for the at least two mobile communication devices, maintains a database of profiles of users desiring to communicate with other identified users when they are at a common location, and automatically initiates a contact with at least one of the at least two mobile communication devices in order to effect a direct communication between two mobile communication devices in the database when the profiles for the mobile communication devices indicate that such a direct communication should be made.

In accordance with the invention, wireless communication between the third party and the user devices can involve transmission of information by one or both of the mobile devices to the third party and/or reception by one or both of the mobile devices of information from the third party. Similarly, direct communication between two users can involve transmission of information from the network address of the first user to the network address of the second user and/or transmission of information from the network address of the second user to the network address of the first user.

In one embodiment of the invention, the location-related data is the identity of the cell tower with which at least one mobile communication device is communicating. Alternatively, the location-related data is the identity of the base station with which at least one mobile communication device is communicating.

In another embodiment, the location-related data is GPS location data calculated by at least one mobile communication device. Alternatively, the location-related data is the GPS location data of at least one mobile communication device calculated by a remote source.

In a further embodiment, the location-related data is in the form of a message from at least one mobile communication device including, for example: an address, such as a street address or zip code; an intersection; the name of a location, such as a business, a club, a concert hall, a golf course, a landmark, a mall, a museum, an office building, a park, a restaurant, a school, a sports venue, a store, a supermarket, or a transportation station; GPS data, sent directly or sent as metadata of a picture or movie; latitude and longitude; a WHAT3WORDS™ or other geographic grid designation; a point on a map; or, a picture or movie of a location. The message can be, for example, a text message, a telephone call, a voicemail message, an email, a TWITTER™ tweet, an instant message, a map with the user's location identified, a SNAPCHAT™ picture or video, etc.

In one embodiment, the database is maintained by a telecommunications service provider. Alternatively, the database is maintained by a third party server, or the database is maintained by at least one mobile communication device.

In another embodiment, each of the wireless communications between each user and the third party, and the initiated contact by the third party to either or both of the first and second users, can be, for example, a text message, a telephone call, a voicemail message, an email, a tweet, an instant message, a map with the user's location identified, a Snapchat picture or video, etc. The communication to the third party by a user can contain the GPS coordinates of the user, or other information identifying the user's location, such as an address, and also can contain the speed at which the user is moving. The initiated contact by the third party to one or both of the users can give the approximate distance between the users. The identified users in a profile can be from among a user's contacts such as GMAIL™ contacts, or from social media data from social networks or the like, such as from among a user's FACEBOOK™ friends, from among a user's Twitter followers, from among a user's APPLE WATCH™ friends list, or from among persons who “like” a person or entity on Facebook. Alternatively, the identified users can be from a list of potential dates provided by a dating site such as TINDER™.

In still another embodiment, the method and apparatus can be used with advertising-related information between, for example, vendors and service providers on the one hand, and potential customers on the other hand. For example, a restaurant chain, such as Burger King, can maintain a profile which includes all persons who have “liked” Burger King on Facebook, and which requires no minimum distance for the initiation of a contact by the third party. If those persons who have “liked” Burger King on Facebook have included Burger King in their profiles, then whenever one of those persons is within a distance from a Burger King set by that person's profile, a contact will be initiated by the third party to Burger King, which can automatically respond to the contact by sending the person a coupon or other promotion, or a means, such as a link, or a button, to obtain a coupon or other promotion.

In lieu of contacting Burger King, the third party can contact the person and provide the person with a hyperlink, such as a an active email address or telephone number, or a button preprogrammed with a network address, to obtain a coupon or other promotion. Of course, the third party also can contact both Burger King and the person.

Alternatively, the profile maintained by Burger King can indicate that it includes every party other than Burger King itself that has a profile in the database, not just those parties that have “liked” Burger King on Facebook, so that Burger King's promotions can be sent to all persons who include Burger King in their profiles. From a consumer's point of view, this will enable a consumer to obtain a coupon for lunch at a nearby Burger King by simply adding Burger King to the consumer's profile. This will be particularly convenient, for example, if the consumer were driving in an unknown area, and wanted to have lunch at a Burger King.

In addition to, or in lieu of, its profile as “Burger King”, Burger King can be listed in the database as a member of one or more pre-designated sets of users, such as “Restaurants” and “Fast Food”. The names of such pre-designated sets will be determined by the party that maintains the database. Accordingly, were the driver of the previous example to add “Fast Food” to his or her profile, rather than adding “Burger King”, the driver will obtain the Burger King promotion, and also any offered promotions from all of the other close-by Fast Food restaurants in the database. It is understood that these are only examples, and that other types of businesses and service providers can use this communication method.

These and other features of the present invention will be described in more detail with respect to the following drawing wherein:

### BRIEF DESCRIPTION OF THE DRAWINGS

FIG. 1A is a schematic of a wireless telephone network in accordance with the present invention;

FIG. 1B is a schematic of a further step in the method illustrated with respect to FIG. 1A;

FIG. 2 is a schematic of another embodiment of a wireless telephone network in accordance with the present invention; and

FIG. 3 is a block diagram of a wireless telephone for use in the method and apparatus of the present invention.

### DETAILED DESCRIPTION OF THE PREFERRED EMBODIMENTS

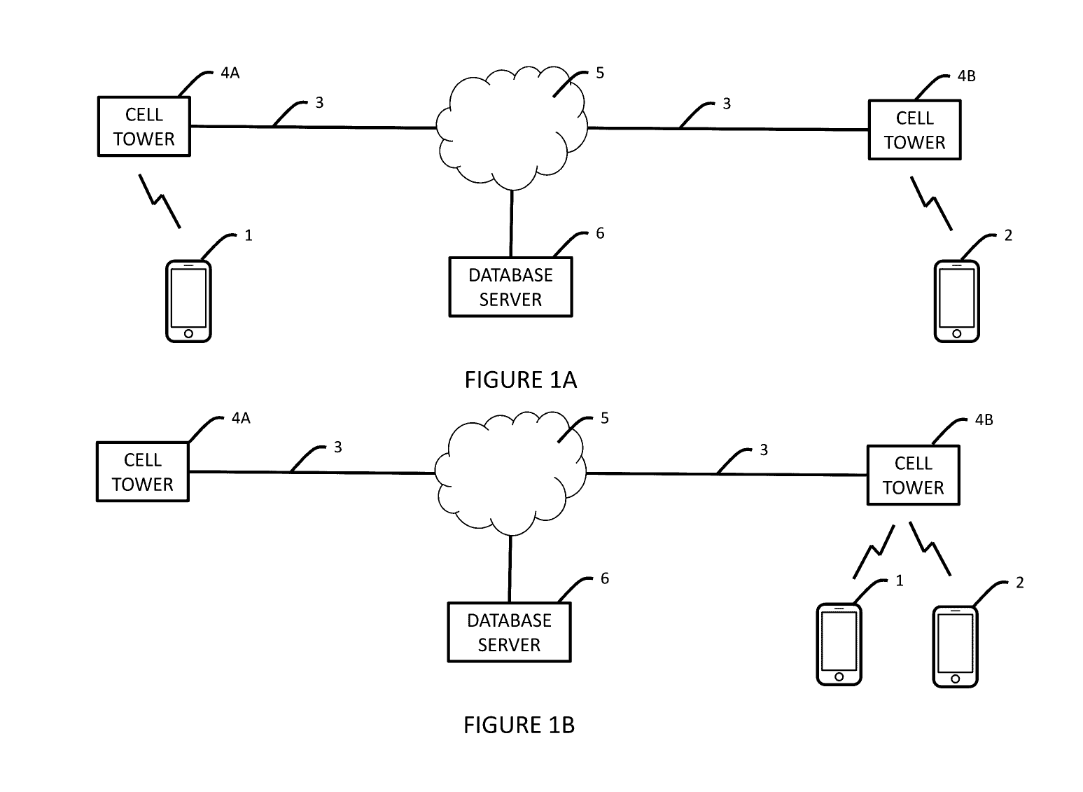

As shown in FIG. 1A, a wireless telephone communications network 5 includes cell towers 4A and 4B connected by communication lines 3 to the network and enabling wireless communication devices 1 and 2 to communicate with each other. Also connected to the network 5 is a database server 6 whose function will be described in more detail below.

While the network is shown as a wireless telephone network, it is understood that the wireless network of the present invention can be any wireless network, including satellite communications, Wi-Fi, and Bluetooth. In addition, the network can include other networks for the transmission of voice and data, such as the Internet, a cable television network, a satellite dish network, a frame relay network, a local area network, the PSTN, or a combination of any of these. Moreover, it is understood that the invention, when the network is a telephone network, is not limited to any particular telephone network, and that, in particular, telephone networks that handle data transmissions as well as voice transmissions are particularly useful, an example being LTE networks. Also, while cell towers are shown for a wireless telephone network, it is understood that the infrastructure communicating with the wireless mobile devices can be base stations, access points, hot spots, picocells, femtocells, and other devices configured to wirelessly communicate with mobile radio devices.

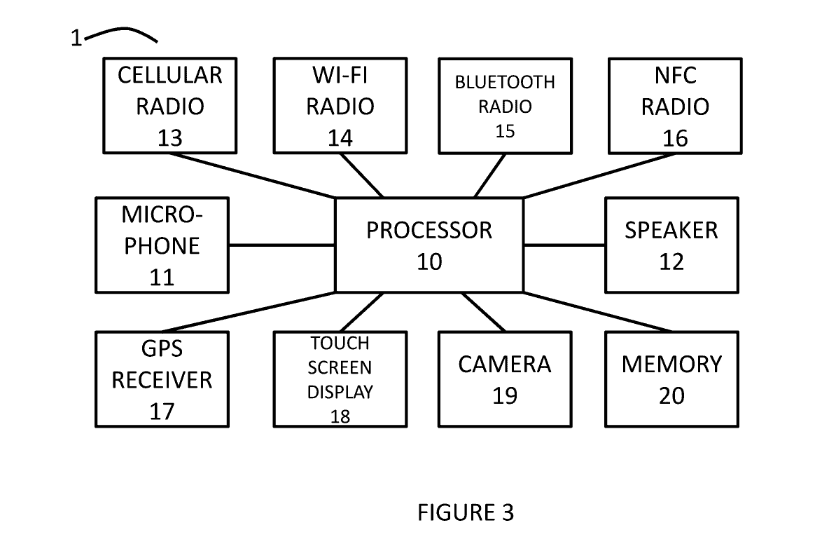

The mobile devices 1 and 2 that are shown in FIG. 1A are preferably mobile telephones, and can be mobile phones running the IOS operating system, the ANDROID™ operating system, the BLACKBERRY™ operating system, and/or the WINDOWS™ mobile operating system, or any other operating system that allows applications to be run. Telephones, such as the Apple IPHONE™ 6™ and 6 PLUS™, the Samsung S5™ and S6™, the HTC ONE™, Nokia LUMIA™ 540 and 640, and the Blackberry Z10™ and Q10™, are examples of mobile telephones that can be used in the present invention. The details of telephones such as these will be discussed in more detail with respect to FIG. 3.

In addition, the mobile devices can be PDAs, tablet devices such as the Apple IPAD™ and the Samsung GALAXY™ tablet, and ultraportable laptops with wireless capability.

The database server 6 hosts a database obtained from profile information received from the users of devices 1 and/or 2, for example, by way of a dedicated application running on the devices 1 and/or 2 or by way of a direct communication using a browser running on devices 1 and/or 2. Alternatively, the users of devices 1 and/or 2 may have used a laptop computer or a desktop computer to upload the profile information to the server 6. In another embodiment, the database server can obtain the profile information from the cloud, if the relevant information is available and accessible to the server. Each entry in a profile can be entered into the profile as part of a group of entries or individually. In addition, it is understood that a user can edit a profile by adding or removing identified users, changing distance preferences, time preferences and/or communication preferences, to name just a few.

The profile information for a user preferably includes at least the following four elements: (1) a list of individuals and/or businesses with which the user desires to communicate when the user and the individual are at the same location; (2) a distance requirement for the distance from another user which, if the other user's distance requirement were at least as large, will initiate contact from the third party; (3) whether the user desires only to send a direct communication to another user, only to receive a direct communication from another user, or to do both; and, (4) the type of communication to be initiated. The profile information also can include: (5) the number, mode, and schedule of reminders that the user desires to receive concerning contacts, receipt of which the user did not acknowledge to the third party; and, (6) whether the user desires to utilize the system of the present invention at the present moment. For example, if a first user changed his or her mind about communicating with a second user, then the first user can indicate to the third party that no direct communications are desired, and no contacts will be made thereafter, either to the first user, or to the second user regarding the first user.

The list of individuals and/or businesses in a user's profile can be manually entered by a user one at a time, or can be entered many at a time, for example, from a contact list on the phone, a list of one's Facebook friends, one's Twitter followers, one's Apple Watch friends, or other pre-prepared lists. Of course, a user may select a subset of a pre-prepared list if the user does not desire to enter all of the entries on a list into the user's profile.

The profile element of distance can be variable, depending upon the situation. For example, if the user were in a car on a highway, the distance might be 5 miles, because that distance will be covered in a few minutes. On the other hand, if the user were in a car on a local road, the distance might be 1 mile. If the user were walking, then the distance might be less, for example 0.25 mile. The party which maintained the database can build into its system a means for the user to select easily a variable distance feature, perhaps by allowing the user to choose parameters during initial entry of the distance element into the user's profile, or perhaps by offering the user a menu of several distance schedules, so that the user did not have to change the user's profile often in order to obtain this functionality.

In some embodiments the common location criterion will be met only if the two users were in the same venue, for example, a golf course, a stadium, a mall, a transportation station, a museum, etc. Alternatively, the common location criteria will only be met when the lesser of the two distance requirements provided by the two users is met, i.e., if one user requires a distance of less than 300 feet and the other requires a distance of less than 100 feet, then the 100-foot distance is the one that must be met before a contact is initiated.

The profile also includes the type of contact to be initiated, for example, a text message, a telephone call, a voicemail message, an email, a tweet, an instant message, a map with the user's location identified, a Snapchat picture or video, etc.

In addition to the determination of the location of a user by cell tower or base station information, the location of a phone can be determined, for example, from GPS information sent to the server 6; from a map with the location of the phone marked on it sent to the server 6; from an address sent to the server 6; or, from the name of a place that is sent to the server 6. The server 6 can be administered by a telecommunications provider such as a carrier, an Internet service provider, or by an independent third party that provides the communication service of the present invention on the communication lines of a carrier or an ISP.

In another embodiment, the contact can be initiated when the two users are being served by the same cell tower as is shown in FIG. 1B. As soon as the user's phone 1 in FIG. 1A is moved to the same cell tower 4B as the phone 2, the server 6 will receive this information from either the cell or the phones 1 and 2 themselves and initiate a contact to the phone 1, and/or to the phone 2, to effect a direct communication between the phones 1 and 2. The contact can be, for example, a text message, a telephone call, a voicemail message, an email, a tweet, an instant message, a map with the user's location identified, a Snapchat picture or video, etc. The contact can contain the GPS coordinates of the user, or other information identifying the user's location, such as an address. The contact can give the approximate distance between the users.

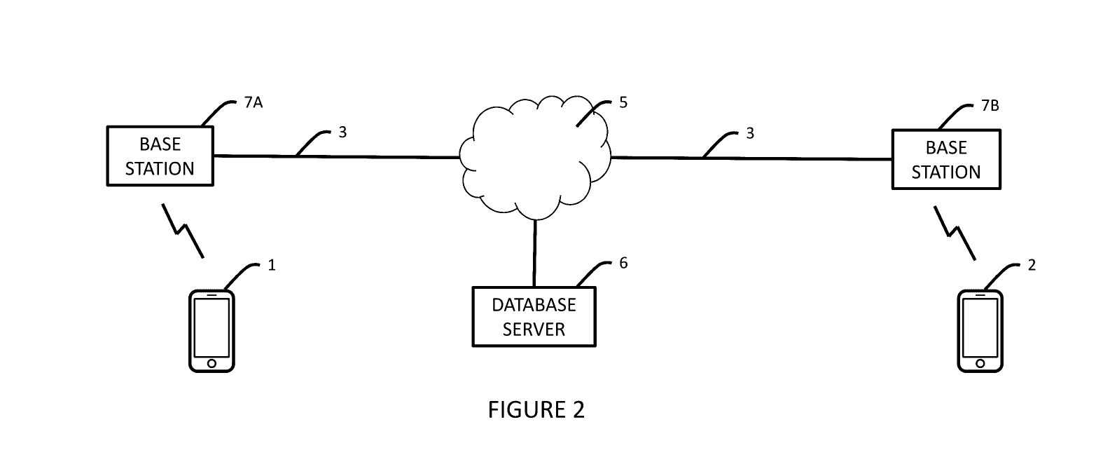

In the embodiment of FIG. 2, two phones are communicating with base stations 7A and 7B respectively. Either or both of the base stations can be a macro LTE base station or a micro base station such as a picocell or a femtocell with limited range. When phone 1 moves to base station 7B, then a contact can be initiated to the phone 1, and/or to the phone 2, to effect a direct communication between the phones 1 and 2. In particular, when the base station is one with limited range, such as those used in urban areas or those used to serve a single location such as an arena, a mall, an office building, a store, or a supermarket, the contact can note the fact that the two users are especially near to each other, and perhaps give an indication of the distance between the two users. The contact can be, for example, a text message, a telephone call, a voicemail message, an email, a tweet, an instant message, a map with the user's location identified, a Snapchat picture or video, etc.

The preferred embodiment of the phone for use with the method and system of the present invention is one that has many or all of the features of the phone of FIG. 3. As shown, the phone has a main processor 10 that controls the many peripheral devices 11-20 that are part of the phone. For voice communication, the phone has microphone 11 and speaker 12. A touch screen display 18 serves as a user interface for the display and keyboard. The phone preferably has one or more radios including an LTE cellular transceiver 13, an 802.11ac Wi-Fi transceiver for WLAN communication, a Bluetooth 2.1 transceiver 15 for short range communication which also includes a Bluetooth 4.2 transceiver for use with, for example, IBEACONS™, and an NFC transceiver 16 for very short range communication. The processor interacts with memory 20, which holds the data and software necessary to carry out the common phone operations. A GPS receiver 17 also is helpful for determining the location of the phone without relying on the network infrastructure for that information. The camera 19 can be used to take pictures or movies (videos) of the current location of the user with the optional metadata which includes GPS information which can be sent to the database server 6 which can determine the location from the GPS data, the picture or movie itself, or both. Examples of phones that have many or all of these capabilities are the Apple iPhone 6 and 6 Plus, the Samsung S5 and S6, the HTC One, the Nokia Lumia 540 and 640 phones, and the Blackberry Z10 and Q10.

The automatic initiation of a contact, and the effecting of a direct communication, can be performed different ways, and some examples are given. For example, when the third party server receives location data regarding the second user which puts the second user in a common location with the first user, the server can send a text message or email to the first user notifying the first user of this fact and suggesting that the first user communicate directly with the second user. This can be expedited, for example, by providing the first user with the network address of the second user, perhaps with suggested wording for a message to the second user, and, most preferably, a button, or hyperlink, in the message labeled, for example, “contact [second user]”, which when pressed, or clicked, by the first user, causes a direct communication from the network address of the first user to the network address of the second user. This communication can be, for example, a text message, a voice call, or an email. The direct communication will then allow the first user and the second user to meet in person and, for example, socialize. In the foregoing example, the third party contacts the first user. If the first user does not acknowledge the contact to the third party, the third party can send reminders from time to time using the same mode of communication or another mode that will be calculated to get the first user's attention. For example, initial contacts can be by email, the first reminder by text message, and the second reminder by a telephone call which will ring or vibrate the phone depending upon the user's settings. Alternatively, the user's profile can contain a parameter which specifies the number, mode, and schedule of such reminders.

Alternatively, the third party can contact the second user or both of the users at around the same time and give both the option of starting the direct communication. Alternatively, the contact also can specify a “do not communicate” option. In the situation where only the first user is contacted, the “do not communicate” response will stop any reminders to the first user for that contact only. Alternatively, the third party also can notify the second user that the first user had requested that the second user not directly communicate with the first user with respect to that contact. In the situation where both users are contacted, the “do not communicate” response by either or both of the users will stop any reminders to both users for that contact only. An “opt out” button can also be provided which will allow the user to easily change the user's profile at that moment to the setting indicating that the user did not want to receive any additional contacts. The user can change that profile setting again when the user again desires to receive contacts.

Although the user profile was described as including names, distances, who is to communicate with whom, and by what medium, other information can be included in the profile, such as the age of the user, the sex of the user, the geographic location of the user, the speed at which the user is moving, the user's preferred time of day for a communication, etc. All of the parameters in the profiles of each of the two users will have to be satisfied before the third party will initiate contact. Accordingly, even if two users were within the distance otherwise sufficient to cause contact to be made by the third party, no contact will be made if, for example, both users were female, and one of the users specified that she wanted to have direct communication only with males, or, as another example, if one of the users specified that he or she wanted to have direct communication only during the hours of noon to 3:00 PM, and only if he or she were then at Disneyland.

While various embodiments of the present disclosure have been described above, it should be understood that they have been presented by way of example only, and not of limitation. Likewise, the various diagrams may depict an example architectural or other configuration for the disclosure, which is done to aid in understanding the features and functionality that can be included in the disclosure. The disclosure is not restricted to the illustrated example architectures and configurations, but the desired features can be implemented using a variety of alternative architectures and configurations. Indeed, it will be apparent to one of skill in the art how alternative functional, logical, or physical partitioning and configurations can be implemented to implement the desired features of the present disclosure. For example, while a single server and a single database are illustrated, the server functions can be distributed over a number of servers, and the database can exist in a number of locations. The functionality of the phones also is for the purpose of example and other implementations are within the scope of this invention. Additionally, with regard to flow diagrams, operational descriptions, and method claims, the order in which the steps are presented herein shall not mandate that the steps of the various embodiments be implemented in the order presented, unless the context dictates otherwise.

Although the disclosure is described above in terms of various example embodiments and implementations, it should be understood that the various features, aspects, and functionality described in one or more of the individual embodiments are not limited in their applicability to the particular embodiment with which they are described, but instead can be applied, alone or in various combinations, to one or more of the other embodiments of the disclosure, whether or not such embodiments are described, and whether or not such features are presented as being a part of a described embodiment. Thus, the breadth and scope of the present disclosure should not be limited by any of the above-described example embodiments, and it will be understood by those skilled in the art that various changes and modifications to the previous descriptions may be made within the scope of the claims.

1-30 (canceled)

31. A communications method comprising the steps by a third party server of:
a. wirelessly communicating with at least two mobile communication devices each having a network address;
b. maintaining a database of profiles of first users of mobile communication devices comprising, for each first user, receiving a set of network addresses of the mobile communication devices of second users with each of whom the first user desires to communicate through the third party server when the mobile communication device of the first user and the mobile communication device of a second user are sufficiently close, wherein at least a portion of the set of network addresses in the profile of each first user is obtained from social media information of the first user;
c. for each first user desiring to communicate, receiving location-related data for the mobile communication device of the first user;
d. for each first user desiring to communicate, receiving location-related data for the mobile communication devices of second users, wherein the network addresses of the mobile communication devices of the second users are in the set of network addresses in the profile of the first user maintained in the database; and
e. for each first user desiring to communicate, initiating a communication through the third party server between the mobile communication device of the first user and the mobile communication device of a second user when the location-related data indicates that the mobile communication device of the first user and the mobile communication device of the second user are sufficiently close.

32. The method according to claim 31, wherein the social media information from which the third party server receives a set of network addresses of the mobile communication devices of the second users is a listing of Facebook friends of the first user.

33. The method according to claim 31, wherein the network addresses in the profile of each first user comprise only network addresses received from the first user.

34. The method according to claim 31, wherein the location-related data is received in a message from at least one mobile communication device including GPS location data of the at least one mobile communication device.

35. The method according to claim 31, wherein the location-related data is received from the identity of a cell tower or a base station with which at least one mobile communication device is communicating.

36. The method according to claim 31, wherein the communication is initiated by the third party server sending a hyperlink to at least one of the first user and the second user to enable at least one of the first user and the second user to commence communication through the third party server with the other of the first user and the second user.

37. The method according to claim 31, wherein the communication is a text message.

38. The method according to claim 31, wherein the communication is a voice message.

39. A communications method comprising the steps by a third party server of:
a. wirelessly communicating with at least two mobile communication devices each having a network address;
b. maintaining a database of profiles of first users of mobile communication devices comprising, for each first user, receiving a set of network addresses of the mobile communication devices of second users with each of whom the first user desires to communicate directly when the first user and a second user are sufficiently close, wherein at least a portion of the set of network addresses in the profile of each first user is obtained from social media information of the first user;
c. for each first user desiring to communicate, receiving location-related data for the mobile communication device of the first user;
d. for each first user desiring to communicate, receiving location-related data for the mobile communication devices of second users, wherein the network addresses of the mobile communication devices of the second users are in the set of network addresses in the profile of the first user maintained in the database; and
e. for each first user desiring to communicate, contacting at least one of the first user and the second user through the third party server when the location-related data indicates that the mobile communication device of the first user and the mobile communication device of the second user are sufficiently close, to effect a direct communication between the network address of the mobile communication device of the first user and the network address of the mobile communication device of the second user.

40. The method according to claim 39, wherein the social media information from which the third party server receives a set of network addresses of the mobile communication devices of the second users is a listing of Facebook friends of the first user.

41. The method according to claim 39, wherein the network addresses in the profile of each first user comprise only network addresses received from the first user.

42. The method according to claim 39, wherein the location-related data is received in a message from at least one mobile communication device including GPS location data of the at least one mobile communication device.

43. The method according to claim 39, wherein the location-related data is received from the identity of a picocell or a femtocell with which at least one mobile communication device is communicating.

44. The method according to claim 39, wherein the direct communication comprises transmission of information from the network address of the mobile communication device of the first user to the network address of the mobile communication device of the second user through another server.

45. The method according to claim 39, wherein the direct communication comprises transmission of information from the network address of the mobile communication device of the first user to the network address of the mobile communication device of the second user.

46. The method according to claim 45, wherein the direct communication is over Wi-Fi.

47. The method according to claim 46, wherein the contacting is via a picocell or a femtocell.

48. A communications apparatus comprising:
a third party server capable of wirelessly communicating with at least two mobile communication devices each having a network address;
wherein the third party server has a memory for maintaining a database of profiles of first users of mobile communication devices comprising a set of network addresses of the mobile communication devices of second users with each of whom the first user desires to communicate through the third party server when the mobile communication device of the first user and the mobile communication device of the second user are sufficiently close, wherein at least a portion of the set of network addresses in the profile of each first user is obtained from social media information of the first user;
wherein, for each first user desiring to communicate, the third party server is capable of receiving location-related data for the mobile communication device of the first user;
wherein, for each first user desiring to communicate, the third party server is capable of receiving location-related data for the mobile communication devices of second users, wherein the network addresses of the mobile communication devices of the second users are in the set of network addresses in the profile of the first user; and
wherein the third party server is capable of initiating a communication through the third party server between the mobile communication device of a first user and the mobile communication device of a second user when the location-related data indicates that the mobile communication device of the first user and the mobile communication device of the second user are sufficiently close.

49. The apparatus according to claim 48, wherein the social media information from which the set of network addresses of the mobile communication devices of the second users is maintained by the third party server is a listing of Facebook friends of the first user.

50. The apparatus according to claim 48, wherein the network addresses in the profile of each first user comprise only network addresses received from the first user.

51. The apparatus according to claim 48, wherein the location-related data is received in a message from at least one mobile communication device including GPS location data of the at least one mobile communication device.

52. The apparatus according to claim 48, wherein the location-related data is received from the identity of a cell tower or base station with which at least one mobile communication device is communicating.

53. The apparatus according to claim 48, wherein the third party server is capable of sending a hyperlink to at least one of the first user and the second user to enable the at least one of the first user and the second user to commence communication through the third party server with the other of the first user and the second user.

54. The apparatus according to claim 48, wherein the communication is a text message.

55. The apparatus according to claim 48, wherein the communication is a voice message.

56. A communications apparatus comprising:
a third party server capable of wirelessly communicating with at least two mobile communication devices each having a network address;
wherein the third party server has a memory for maintaining a database of profiles of first users of mobile communication devices comprising a set of network addresses of the mobile communication devices of second users with each of whom the first user desires to communicate directly when the mobile communication device of the first user and the mobile communication device of the second user are sufficiently close, wherein at least a portion of the set of network addresses in the profile of each first user is obtained from social media information of the first user;
wherein, for each first user desiring to communicate, the third party server is capable of receiving location-related data for the mobile communication device of the first user;
wherein, for each first user desiring to communicate, the third party server is capable of receiving location-related data for the mobile communication devices of second users, wherein the network addresses of the mobile communication devices of the second users are in the set of network addresses in the profile of the first user; and
wherein the third party server is capable of contacting at least one of the first user and the second user through the third party server when the location-related data indicates that the mobile communication device of the first user and the mobile communication device of the second user are sufficiently close, to effect a direct communication between the network address of the mobile communication device of the first user and the network address of the mobile communication device of the second user.

57. The apparatus according to claim 56, wherein the social media information from which the set of network addresses of the mobile communication devices of the second users is maintained by the third party server is a listing of Facebook friends of the first user.

58. The apparatus according to claim 56, wherein the network addresses in the profile of each first user comprise only network addresses received from the first user.

59. The apparatus according to claim 56, wherein the location-related data is received in a message from at least one mobile communication device including GPS location data of the at least one mobile communication device.

60. The apparatus according to claim 56, wherein the location-related data is received from the identity of a picocell or femtocell with which at least one mobile communication device is communicating.

61. The apparatus according to claim 56, wherein the direct communication comprises transmission of information from the network address of the mobile communication device of the first user to the network address of the mobile communication device of the second user through another server.

62. The apparatus according to claim 56, wherein the direct communication comprises transmission of information from the network address of the mobile communication device of the first user to the network address of the mobile communication device of the second user.

63. The apparatus according to claim 62, wherein the third party server is capable of direct communication over Wi-Fi.

64. The apparatus according to claim 63, wherein the third party server is capable of contacting via a picocell or a femtocell.
